(19) United States
(12) Patent Application Publication
(10) Pub. No.: US 2020/0072424 A1
(43) Pub. Date: Mar. 5, 2020

(54) LANTERN APPARATUS

(71) Applicant: The Coleman Company, Inc., Wichita, KS (US)

(72) Inventors: Matthew G. Law, Wichita, KS (US); Zachary R. King, Lakewood, CO (US); Brian Kincaid, Golden, CO (US); Philip Dinsmore, Wichita, KS (US)

(21) Appl. No.: 16/467,128

(22) PCT Filed: Dec. 4, 2017
(86) PCT No.: PCT/US17/64565

§ 371 Date: Jun. 6, 2019

Related U.S. Application Data
(60) Provisional application No. 62/430,753, filed on Dec. 6, 2016.

(51) Int. Cl. F21L 4/08; F21V 23/04; F21V 21/096

(52) U.S. Cl. CPC F21L 4/08; F21V 21/0965; F21V 23/0414

(57) ABSTRACT

A lantern is provided having a base portion in or on which a plurality of removable sub-lanterns may be stored or releasably attached. Each sub-lantern includes a separate power source capable of independently powering the sub-lantern. The sub-lanterns are separately selectively illuminable. The lantern base of a lantern includes a docking station having a docking station power source capable of simultaneously powering all sub-lanterns attached to the docking station simultaneously or any subset of the sub-lanterns attached to the docking station.

### CROSS-REFERENCE TO RELATED APPLICATIONS

This application claims the benefit of U.S. Provisional Application No. 62/430,753, filed Dec. 6, 2016, which is hereby incorporated by reference in its entirety.

### FIELD OF THE INVENTION

The invention relates to a portable lantern, and more particularly to a lantern having an illuminable lantern base and a plurality of removable light sticks containable within the lantern base.

### BACKGROUND OF INVENTION

Lanterns are portable light sources capable of standing on their own and illuminating a general area. Lanterns are commonly used in connection with outdoor activities such as camping where other light sources may be impractical or unavailable. Lanterns are also often used at home, work, or in other buildings as a spare light source during power outages or other scenarios where light is otherwise not available.

Lanterns can utilize a variety of different types of power sources. For example, they can utilize mantles to burn fuel or have batteries that power electric lights. Electric lanterns are typically used by placing or hanging a lantern in a location to be illuminated, then turning the lantern on to provide power to the electric light source. A lantern may typically be carried by a person from place to place so as to illuminate the general vicinity around the person as he or she moves.

While lanterns are suitable for this general purpose, it can be inconvenient to carry a lantern from place to place if light is needed in more than one area. For example, if two or more people are using a lantern at once, one person may need light in one area while another may need light in another area. Often it is desirable to illuminate several areas that are commonly used at the same time. It is often impractical and not cost effective to carry multiple lanterns for illuminating multiple areas, especially in situations, such as camping, where storage space is limited.

### SUMMARY OF INVENTION

The present disclosure provides multiple embodiments of a portable lantern apparatus. In one embodiment, the portable lantern includes a lantern base with a docking station having a first power supply. The portable lantern further includes a plurality of area lights (also referred to herein as sub-lanterns or light sticks) that are removably connectable to the docking station within the lantern base. Each of the plurality of light sticks preferably has its own second power supply, which may be a rechargeable battery.

The lantern base may include a basin in which the plurality of light sticks may be stored when not in use. The lantern base also preferably includes a docking station within the base. The docking station is configured so that its power supply can power and/or charge each of the plurality of light sticks when connected to the docking station. The power supply can also power a lamp that is housed in the bottom portion of the lamp base. The power supply may supply power to the light sticks via a physical connection or via wireless charging, and the connection between the light sticks and the lamp base may be a physical connection or wireless.

The plurality of light sticks are each configured so that a second power supply associated with each of the light sticks can supply power to illuminate the light stick when disconnected from the docking station.

A lantern cover may also be provided to cover the light stick and lantern apparatus when not in use. The lantern cover is contoured to fit over the lantern base and the light sticks when the light sticks are contained by the basin.

Other embodiments of the lantern apparatus include a lantern base with a first power supply contained therein. The first power supply may be a battery or the like, and may be selectively connectable via any known connector such as any type of USB connector. The lantern apparatus may also include a plurality of light panels that are removably connectable to the sides of the lantern base. Different embodiments of the lantern base are envisioned, which may releasably secure a different number of light panels. For example, one base may be able to releasably secure four panels, two panels, or any other number.

A separate rechargeable docking station may also be provided that can charge light panels. The rechargeable docking station may include, for example, one or more cradles for storing and charging light panels therein.

The light panels are preferably interchangeable with multiple lantern bases. Thus, for example, a light panel may be used in association with a four panel base as well as a one panel base or a two panel base, and vice versa. Each of the plurality of light panels preferably has its own internal power supply, such as a rechargeable battery capable of being recharged by the first power supply in the lantern base or a docking station.

The light panels may include an area light at a front portion, and a flashlight at a top portion. Preferably, the light panels include magnets on back sides thereof. The magnets correspond to magnets located on the lantern bases to allow the light panels to be releasably securable thereto, although other connection mechanisms are envisioned. The light panels may even be immediately releasably attachable to one another at their back sides to form a wider flashlight utilizing the flashlights of the two light panels side-by-side.

### BRIEF DESCRIPTION OF DRAWINGS

FIG. 1 is a perspective view of a lantern apparatus according to the teachings of the present invention;

FIG. 2 is a sectional view of the lantern base of the lantern apparatus shown in FIG. 1;

FIG. 3 is an exploded perspective view of the lantern base of FIG. 2;

FIG. 4 is a front elevation view of a light stick of the lantern apparatus shown in FIG. 1;

FIG. 5 is a side elevation view of the light stick of FIG. 4;

FIG. 6 is an exploded perspective view of the light stick of FIGS. 4 and 5;

FIG. 7 is an exploded perspective view of a lantern cover that can be used with the lantern apparatus shown in FIG. 1;

FIG. 8 is a top plan view of the lantern cover of FIG. 7;

FIG. 9 is a perspective view of a first alternative lantern apparatus according to the teachings of the present invention;

FIG. 10 is a second perspective view of the first alternative lantern apparatus of FIG. 9;

FIG. 11 is an elevation view of a light panel for use with the lantern apparatus shown in FIGS. 9 and 10;

FIG. 12 is a bottom plan view of the light panel of FIG. 11;

FIG. 13 is a perspective view of a back side of the light panel of FIGS. 11 and 12;

FIG. 14 is a perspective view of two light panels like those shown in FIGS. 11-13 placed back to back to form a spotlight;

FIG. 15 is an elevation view of a second alternative lantern apparatus according to the teachings of the present invention;

FIG. 16 is a plan view of the second alternative lantern apparatus of FIG. 15;

FIG. 17 is a perspective view of a third alternative lantern apparatus according to the teachings of the present invention;

FIG. 18 is an elevation view of a rechargeable docking station according to the teachings of the present invention; and

FIG. 19 is a perspective view of the rechargeable docking station of FIG. 18.

All illustrations of the drawings are for the purpose of describing selected embodiments of the present invention and are not intended to limit the scope of the present invention.

### DETAILED DESCRIPTION OF THE INVENTION

The present disclosure is directed to a portable lantern including a plurality of removable sub-lanterns, light panels, or area lights. When the sub-lanterns, formed as light sticks, are connected to the lantern's base, the sub-lanterns are charged by a power source in the lantern base. When the sub-lanterns are removed from the lantern base, they are operable as a separate and distinct light source. In an example embodiment, the lantern base also includes a base lamp operable as an independent light source that can be used by itself or with the sub-lanterns when the base lamp and sub-lanterns are activated.

The lantern may include a docking station with power sources (e.g., primary cell batteries, rechargeable batteries, other direct current (DC) power sources). The sub-lanterns or light panels are preferably removably attachable to the docking station, where the sub-lanterns are in electrical communication with the power source. When the sub-lanterns are attached to the docking station unit, the power source preferably powers the sub-lanterns.

The sub-lanterns also preferably each include a separate power source such that when the sub-lanterns are separated from the docking station, the sub-lantern power source provides power to light the removed sub-lantern.

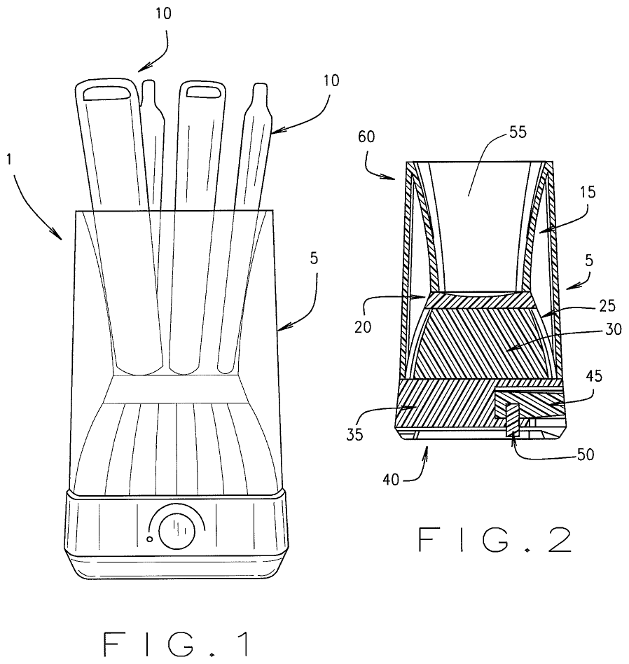

Referring now to the drawings in which like reference numbers refer to like elements, there is shown in FIG. 1 a lantern apparatus 1 including a lantern base 5 and a plurality of sub-lanterns, or light sticks, 10 contained within the lantern base 5. The lantern base 5 can take on a number of different shapes and configurations to contain the individual light sticks 10 therein.

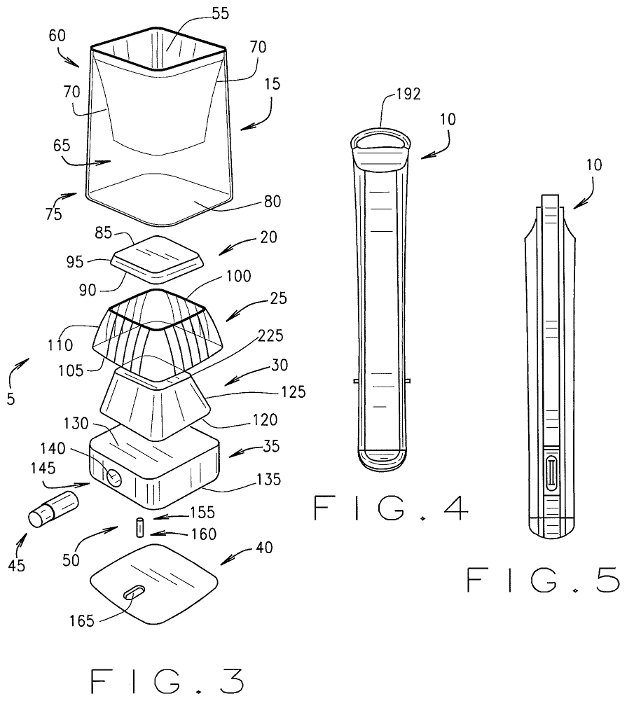

A preferred embodiment of the lantern base 5 is shown in FIGS. 2 and 3. FIG. 2 illustrates various components that make up the lantern base 5. Lantern base 5 preferably includes a base cover 15, base cap 20, base top lens 25, base light 30, base ring 35, base foot 40, knob 45, and pin 50. The various manners in which the above listed components are engaged and/or connected with one another is described in greater detail herein below when describing FIG. 3.

When the base cover 15 is attached to the base cap 20, a basin 55 is formed in an upper end 60 of the base cover 15. The base top lens 25 is preferably attached just below the base cap 20. When the base light 30 is activated, light from the base light 30 may shine through the base top lens 25. The base ring 35 preferably houses electronics for controlling the base light 30 and is positioned below the base light 30. The base ring 35 may include a knob 45 for controlling its internal electronics that is attached to a base foot 40 by a pin 50, as described below. The base cover 15 may be made of a polished plastic material and is preferably clear, or another suitable material as would be understood. In the illustrated embodiments, the base cover 15 is generally shaped as a rectangular prism, but in alternative embodiments may take on other shapes.

Turning now to FIG. 3, at an upper end 60 of the base cover 15, the basin 55 may be funnel-shaped. The basin 55 extends downwardly into an interior cavity 65 of the base cover 15. The basin 55 may include contoured side walls 70 that taper inwardly from the upper end 60 of base cover 15 toward its lower end 75. A bottom portion 80 of the basin 55 is preferably positioned and located toward the middle of the base cover 15. The bottom portion 80 of the basin 60 is preferably open to the interior cavity 65 of the base cover 15. The bottom portion 80 may therefore be formed as a through-hole, or aperture.

The bottom portion 80 may be sized and shaped similarly to the base cap 20 such that it can receive and engage the base cap 20. The base cap 20 includes each of an upper surface 85 and a lower surface 90, wherein side walls 95 are formed between the upper and lower surfaces 85, 90. As shown, side walls 95 may be tapered outwardly from the upper surface 85 toward the lower surface 90. When the base cap 20 is received within the bottom portion 80, the tapered side walls 95 help the base cap 20 to be received within the bottom portion 80 of the base cover 15. When the base cap 20 is engaged within the bottom portion 80 of the base cover 15, the base cap 20 serves as a floor to the basin 55. The light sticks 10 may then be retained within the basin 60 by the base cap 20 acting as a floor for the light sticks 10. Though the base cap 20 may be comprised of a variety of materials, in an example embodiment it is made of a polished metal or plastic.

The base top lens 25 preferably includes an open upper portion 100 and an open lower portion 105. Exterior side walls 110 of the base top lens 25 preferably taper outwardly from the upper portion 100 to the lower portion 105. As such, the surface area of the open space contained within the upper portion 100 is less than the surface area of the open space contained within the lower portion 105. The perimeter of the base top lens 25 surrounding the upper portion 105 is preferably only slightly smaller than the perimeter of the upper surface 85 of the base cap 20. Thus, when the base cap 20 is placed on the base top lens 25, the upper portion 100 of the base top lens 25 engages within the upper surface 85 of the base cap 20. In an example embodiment, the base top lens 25 and its side walls 110 are made of a polished, clear plastic, although other materials are envisioned. When the base light 30 is positioned and located within the base top lens 25, the base light 30 may shine through the base top lens 25 and illuminate an area surrounding the lantern 1.

In an example embodiment, the base light 30 is made of a matte plastic and is a cool white color, although other materials and colors are envisioned. Like the base top lens 25, an upper portion 115 of the base light 30 is larger in area than a lower portion 120 of the base light 30. Thus, side walls 125 of the base light 30 also taper outwardly from the upper portion 115 to the lower portion 120. The base light 30 may include a light source such as a light bulb contained therein, or it may be a light source itself. The base light 30 (and light sticks 10) may be motion or sound activated, or may be remote controlled by NFC, Bluetooth, RF, or the like. The base light 30 may illuminate in 360 degrees or may be selectively limited to a lower radius, such as 180 degrees.

When the lantern base 5 is assembled, the base light 30 is releasably engaged to an upper surface 130 of the base ring 35, which is larger in area than the base light 30. A lower surface 135 of the base ring 35 may be releasably engaged to the base foot 40 when the lantern base 5 is assembled. In an example embodiment, the base ring 35 is comprised of a matte plastic, although other materials are envisioned. An interior of the base ring 35 preferably includes a power source (not illustrated) for powering the base light 30, with which it is preferably in electronic communication.

The power source may be any known power source, including primary cell batteries, rechargeable batteries, direct current (DC) power sources, or the like. The power source may be able to charge and recharge the light sticks 10, either wirelessly or directly via a more traditional power supply method such as by any USB variant or other electrical charging such as solar power. Light sticks 10 may therefore work with any lantern base 5. A stand-alone charger (battery powered or otherwise) may also be used to charge the light sticks 10. The lantern base 5 itself may be powered or rechargeable via any USB variant, or by batteries, or by a standard wall outlet. Light sticks 10 and/or lantern base 5 may have battery level indicators.

In an alternative embodiment, a second power source may be provided within the base ring. In such an embodiment, the first power source may be responsible for powering the light source of the base light 30, while the second power source may be responsible for charging or powering (when the light sticks 10 are activated and contained within the lantern base 5) the light sticks 10.

The base ring 35 also preferably includes an aperture 140 in which the knob 45 may be releasably engaged. Preferably, the aperture 140 and the knob 45 are located on a front side 145 of the base ring 35, though they could be located on any of the sides of the base ring 35 (or other component including the electronics). The knob 45 is preferably in mechanical connection with the electronics that control the power source or power sources within the base ring or elsewhere. The knob 45 preferably controls the brightness of the base light 30 and its light source so that the lantern base 5 and its illumination is dimmable. The knob 45 also may allow a user to change the color of illumination of the base light 30, and/or may allow a user to turn the base light 30 on or off.

An underside of the knob 45 (not illustrated) also preferably includes a receiver (not illustrated) which may be embodied as a cavity or a through-hole. The receiver preferably receives and engages an upper end 155 of the pin 50, which is perpendicular to the knob 45. A lower end 160 of the pin 50 is selectively engageable within an aperture track 165 of the base foot 40. The pin 50, when engaged within the track 165, preferably is able to slide inwardly and outwardly to provide another means for controlling the base light 30 and its light source. As a non-limiting example, pulling or pushing the knob 45 may turn the lantern 1 off or on.

Electronics within the lantern base 5 may also communicate with the light sticks 10 wirelessly or through a physical connection. For example, adjustments made to the light output or color of the base light 30 via use of knob 45 may be communicated to the light sticks 10 as well. Similarly, placing an otherwise “off” light stick 10 into the basin 55 while the base light 30 is on may cause the light stick 10 to turn on. Placing an otherwise “on” light stick 10 into the basin 55 while the base light 30 is off may cause the light stick 10 to turn off. Such actions may occur between wired or wireless communication modules (not illustrated) within the light sticks 10 and lantern base 5, as directed by one or more than one controller (not illustrated). Additionally, light sticks 10 may communicate with other light sticks to coordinate actions.

The base foot 40 preferably has a surface area minimally larger than the surface area of the lower surface 135 of the base ring 35. As such, the base ring 35 is preferably able to fit within the base foot 40 when the base lantern 5 is assembled. The base foot 40 is preferably plastic, though in alternative embodiments could be comprised of a rubber that provides traction to keep the base lantern 5 stable on a smooth or slippery surface like a table top.

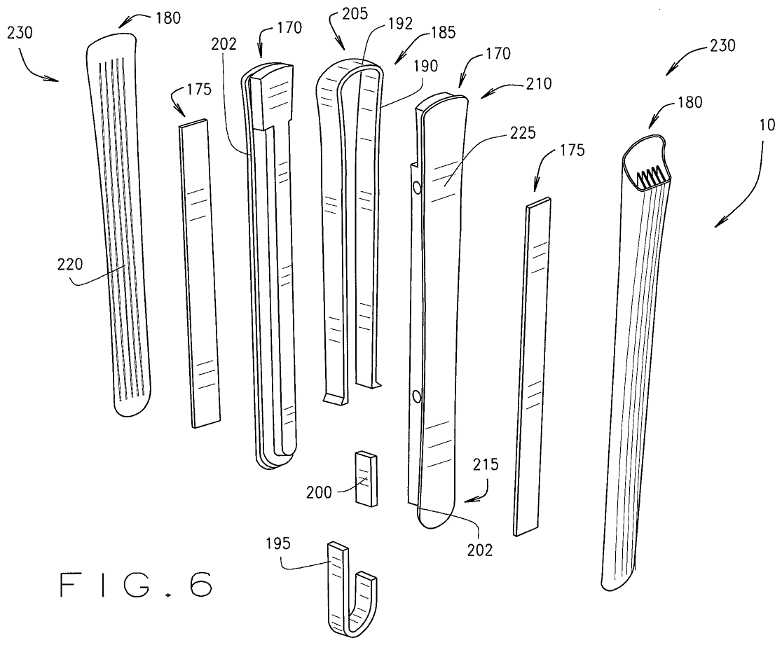

FIG. 4 illustrates the light stick 10 from a front elevation view, and FIG. 5 provides a side elevation view of the same. In some embodiments, the light sticks 10 may link together to form a larger light unit. Turning now to FIG. 6, each light stick 10 may include two selectively engageable chassis 170 that house electronic components for powering light sources associated with the light stick. In an example embodiment, the two chassis 170 are comprised of a matte plastic, although other materials are envisioned. Two light strips 175 are preferably engaged with the chassis 170 and illuminate through two exterior lenses 180 when activated. A strap member 185 may include each of an upper body member 190 and a lower body member 195. A button 200 may be supported on the chassis 170. The manner in which these components engage and/or connect is described below in greater detail.

At a middle portion 205 of the light stick 10, the two chassis 170 may be selectively engageable with one another in a manner commonly known and understood in the art. For example, a friction fit or a latch or pin mechanism may be used. One or both chassis 170 may include a cavity portion (not illustrated) that includes various electronic components for powering and controlling the light strips 175. Such electronic components are of a type commonly known and understood in the art. Preferably the power source housed within the cavity of either or both chassis 170 is able to be charged and recharged by the power source housed within the base ring 35, or by a separate power source.

A perimeter of the two chassis 170 is preferably surrounded by the strap member 185. The chassis 170 each preferably include perimeter track members 202 surrounding their interior perimeters. The track members 202 preferably have a perimeter just smaller than that of the chassis 170. The strap member 185 may thereby be inlayed within the track members 202 when the light sticks 10 are assembled. The upper body member 190 of the strap member 185 preferably covers upper portions 210 of the chassis 170 when a light stick 10 is assembled. The upper body member 190 preferably extends upwardly and through the chassis 170 so that it sticks out of the top of the light stick 10 to form a loop 192 (also shown in FIG. 4). Track members 202 may allow the strap member 185 to slide therealong. This allows the loop 192 to be expandable when pulled, such that it can create a larger loop. The loop 192 may serve a number of practical purposes when the light stick 10 is in use, for example being wrapped around a user's wrist or being hung from a tent ceiling.

Similarly, the lower body member 195 of the strap member 185 covers the lower portion 215 of the chassis 170 when a light stick 10 is assembled. In an example embodiment, the upper body member 190 is comprised of a soft-touch rubber, and the lower body member 195 is constructed of a soft-touch plastic, although other materials are envisioned. The upper body member 190 is illustrated as being in the shape of an inverted letter “U” though it is constructed as such to complement the shape of the chassis 170. In other embodiments, were the chassis 170 to take on another shape, the upper body member 190 similarly may take on another shape to complement the shape of the chassis 170. The lower body member 195 is illustrated as being “J”-shaped, though like the upper body member 190, it may take on another shape in alternative embodiments.

Together the upper and lower body members 190, 195 may not surround the perimeter of the chassis 170. Thus, the button 200 is preferably positioned and located between the upper and lower body members 190, 195 so that the perimeter of the chassis 170 is largely covered by the strap member 185.

The button 200 is preferably in electronic communication with the electronic controls so that a user can turn the light sources within the light strips 175 on or off, change the color of the light sources, or otherwise control the operation of the light sources within the light strips 175. The button 200 is preferably constructed of a soft-touch plastic, but may be constructed of a rubber in alternative embodiments.

The light strips 175 are preferably located outwardly relative to the respective chassis 170. The light strips 175 are similarly preferably comprised of a matte plastic. The light strips 175 may be controlled by the electronic components within the chassis 170 to illuminate a light source (not illustrated) when the light sticks 10 are in use. The respective light strips 175 may be housed within a cavity 220 of the lenses 180, or alternatively may be fixedly attached to an outside surface 225 of the respective chassis 170.

At exterior portions 230 of the light sticks 10, the lenses 180 are provided to reflect light generated by the light strips 175. In an example embodiment, the lenses 180 are comprised of a clear, polished plastic, although other materials are envisioned. When the light sticks 10 are assembled (as shown in FIGS. 4 and 5) the lenses 180 are selectively engageable with the outside surfaces 225 of the chassis 170. The lenses 180 may be engageable with the chassis 170 in a number of known ways, including a friction fit or use of a latching mechanism, or the like.

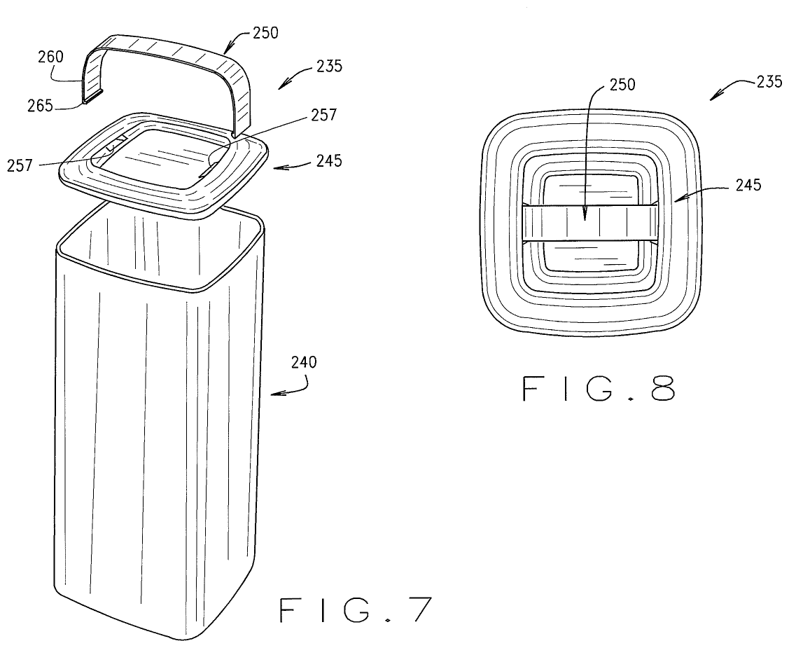

Turning now to FIGS. 7 and 8, the lantern base 5 and the light sticks 10 may also be covered when not in use. Thus, a lantern cover 235 may further be provided that may be selectively placed on or taken off of the lantern apparatus 1. The cover 235 may include a tubular base member 240 which is selectively engageable with a lid member 245. A handle member 250 for carrying the cover 235 may be further selectively engageable with the lid member 245.

The tubular base member 240 preferably includes an upper opening 255 having a generally square shape with rounded corners, although other shapes are envisioned depending on the shape of the lantern base 5. The base member 240 also preferably includes a lower opening (not illustrated) through which the lantern base 5 and the light sticks 10 enter when the cover 235 is placed over the lantern 5.

The lid member 245 may be releasably attached to the tubular base member 240 in a variety of ways including a friction fit or use of a latching mechanism or the like. The lid member 245 preferably protects the lantern 1 and its base 5 and light sticks 10 from collecting dust when stored inside. It also may protect the lantern 1 and its base 5 and light sticks 10 from weather elements when stored outside during camping or other outdoor recreational activities.

The lid member 245 also preferably includes two apertures 257 through which end portions 260 of the handle member 250 may be inserted and subsequently releasably attached thereto. The end portions 260 of the handle member 250 preferably include inwardly facing ledge members 265 that project inwardly from the handle member 250. After the ledge members 265 are inserted through the apertures 257, the ledge members 265 oppose an interior surface (not illustrated) of the lid member 245 such that the handle member 250 cannot be removed from the lid member 245 without manipulating the ledge members 265 to pass through the apertures 257.

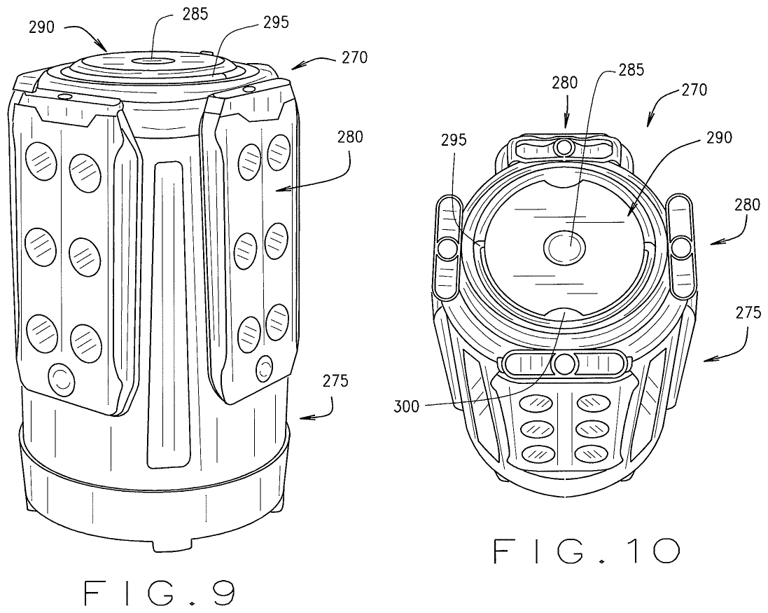

Turning now to FIGS. 9 and 10, another embodiment of a lantern apparatus 270 is provided. The lantern apparatus 270 includes each of a lantern base 275 and a plurality of light panels 280 selectively engageable with the lantern base 275. The lantern base 275 preferably includes a power source (not illustrated) that is able to power and/or charge the light panels 280. The power source may be any of the sources described above in relation to the lantern apparatus 1 (e.g., primary cell battery, rechargeable battery, DC power source).

A power button 285 on a top portion 290 of the lantern base 275 is preferably in electronic communication with the aforementioned power source of the lantern base 275. The power source is also preferably in electrical communication with a light source (not illustrated) within the light panels 280. Such electronic communication may be wireless or via a physical connection, such as a USB connector engaged with each light panel 280, or may be accomplished via the transmission of power through electrical contacts between the lantern base 275 and the panels 280. Thus, when the power button 285 is activated, all or some of the light panels 280 may be turned on. The lantern base 275 and/or the light panels 280 may further include an indicator for the battery level or level of another power source.

The lantern base 275 may also include a connector (not illustrated) that may output power from the first power source to an external component like a cell phone. The connector may for example be a USB or micro-USB charger, though other known or foreseeable outputs are contemplated.

A handle member 295 is preferably also located on the top portion 295 of the lantern base 275. The handle member 295 may be semi-circular in shape, and may be constructed of a variety of materials. Preferably the handle member 295 is hinged such that it may be rotated in a stowed position and contained within a semi-circular recess 300 (shown in FIG. 10) on the top portion 290 of the lantern base 275 when not in use. On the other hand, the handle member 295 may also be rotated upwardly so that it may be used to carry the lantern apparatus 270 when it is being carried as a lantern.

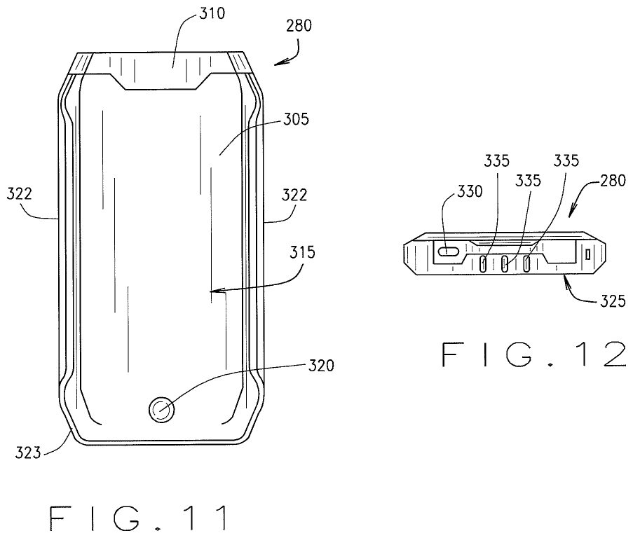

Each individual light panel 280 preferably includes each of an area light 305 and a flashlight 310, as shown in FIG. 11. The area light 305 is preferably used to illuminate a wider, broader area, while the flashlight 310 is preferably used to “spotlight” a particular area. Each individual light panel 280, like the light sticks described above preferably includes a power source (not illustrated) that is able to power the area light 305 and/or the flashlight 310. The power source may be a rechargeable battery such as a lithium ion battery that is housed within the light panel 280, but the power source may be any commonly known or foreseeable type of rechargeable power source.

A front portion 315 of the light panels 280 that includes the area light 305 also preferably includes a power button 320 located thereon that can control when the lights 305, 310 are activated. The power button 320 may allow a user to toggle between whether the area light 305, the flashlight 310, both lights 305 and 310, or none of the lights are activated. In alternative embodiments, the power button 320 may control the color of light emitted by the lights 305, 310. Edges 322 and corners 323 of the light panels 280 may be reinforced with rubber or another material to increase grippability as well as to protect the panels 280 when dropped.

As shown in FIG. 12, a bottom portion 325 of the light panels 280 may include a micro-USB port 330 for accepting charge into or providing charge out of the internal power source (e.g., for charging an external device like a cell phone). In alternative embodiments the port 330 may be a traditional USB port or other port for connecting to and powering an external device from the power source of the light panel 280.

The bottom portion 325 of the light panel 280 may also include prong members 335 that may be selectively engageable with complementary electrical contacts in a lantern base 275 (not illustrated). When the light panel 280 is releasably engaged to lantern base 275, the prongs 335 are preferably in communication with the electrical contacts on the lantern base. The power source in the lantern base is then preferably able to recharge the power source within the light panel 280 via the prongs 335 in a known manner. In an alternative embodiment, the light panels 280 may not include prongs, and the panels 280 may be chargeable in an alternative method, for example wirelessly, by solar power or simply by using the micro-USB port 330 or another similar port. Alternatively, the light panels 280 may be provided with an adaptor that converts the prongs 335 to a micro-USB or other power source to increase the adaptability of the light panels 280.

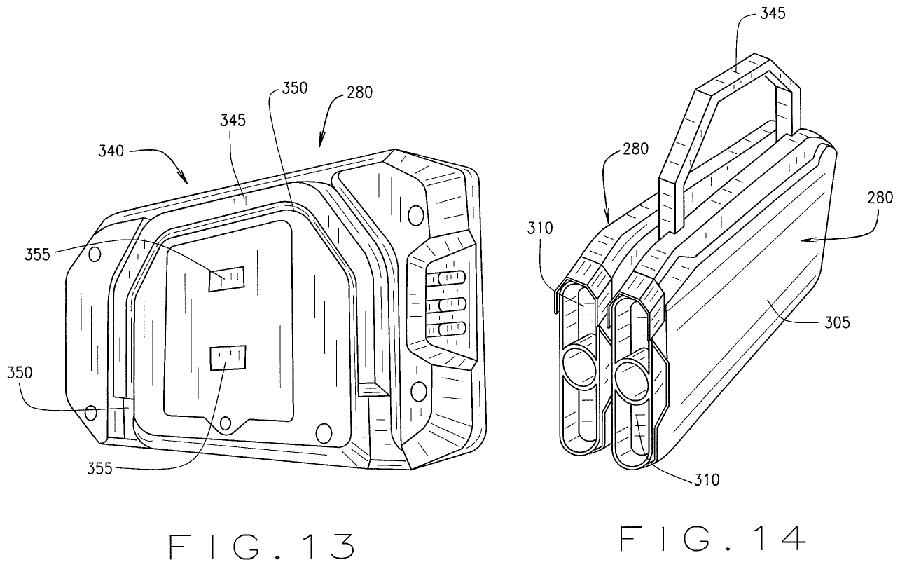

A low profile rear portion 340 of the light panel 280 is provided in FIG. 13. The rear portion 340 preferably includes a hinged handle 345. The handle 345 can be used to carry a light panel 280 when in use. When the handle 345 is not being used, it may be stowed in a recess 350 that corresponds in size and shape to the handle 345. The rear portion 340 of the light panel 280 also preferably includes magnets 355 mounted thereon or embedded therein. Preferably, lantern base 275 includes magnets (not illustrated) that are attracted to magnets 355 to releasably secure the light panels 280 to the lantern base 275, as shown in FIGS. 9 and 10. In an embodiment where the light panels 280 are powered using solar power, a solar panel may cover the rear portion 340 of the light panels 280.

In addition to securing the light panels 280 to a lantern base, the magnets 355 may serve at least one additional purpose. Two light panels 280 may be positioned such that their magnets 355 attract one another and secure two light panels 280 to one another (see FIG. 14). When this occurs, the two flashlights 310 of the light panels 280 may work side by side to generate a stronger, more even spotlight. Additionally, the area lights 305 of the two light panels 280 may also be used to create a miniature version of a lantern.

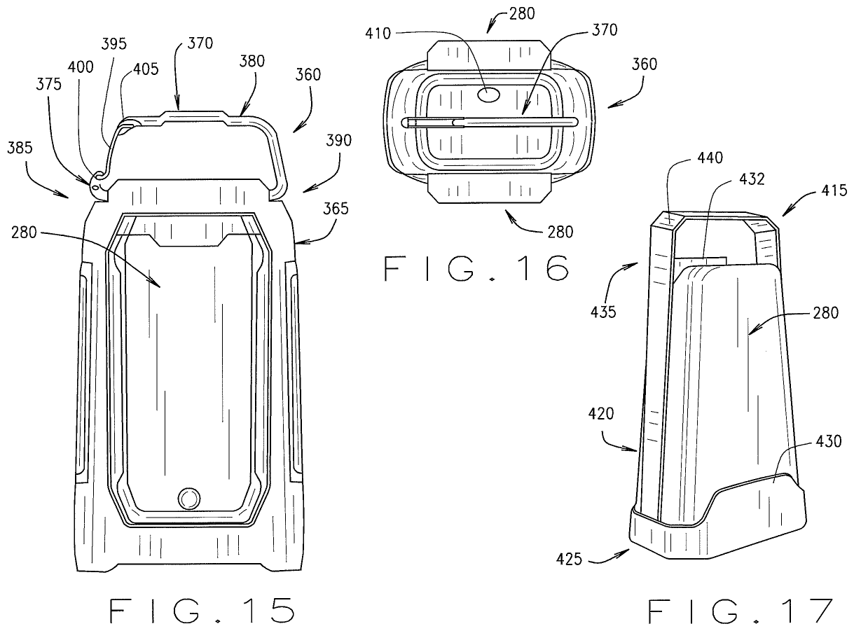

Other embodiments of a lantern apparatus may have a lantern base that is able to secure varying numbers of light panels 280. In those alternative embodiments, described below, the light panels 280 may be interchangeable so that they may operate with any of the embodiments. FIGS. 15 and 16 illustrate a non-limiting example of a lantern apparatus 360 that includes a lantern base 365 and two light panels 280 releasably attached thereto. The lantern base 360 may further include a handle 370 that is designed as a carabiner, as commonly known in the art. In such an embodiment, the handle 370 includes each of a first arm 375 and a second arm 380.

The first arm 375 is preferably fixedly attached to a first side 385 of the lantern base 360, where it extends outwardly and upwardly therefrom. The second arm member 380 may be fixedly attached to a second side 390 of the lantern base 360, substantially opposite the first side 385. The second arm member 380 preferably extends outwardly from the first side 390 before extending upwardly and curving inwardly toward the first side 385. A pin member 395 connects end portions 400 and 405 of the first arm member 375 and second arm member 380, respectively. The pin member 395 is preferably hingedly attached to the first arm member 375 so that the pin member 395 can rotate outwardly from the end portion 400. The pin member 395 is further preferably releasably attachable to the end portion 405 (e.g., by a latch mechanism) so that it may be detached therefrom and reattached if a user would like to hang the lantern apparatus 360 from a loop or other surface.

The light panels 280 are preferably removably attachable to the lantern base 365 by the magnet mechanism discussed above. As in the above discussed embodiments, the light panels 280 may alternatively attach to the lantern base 365 by any other suitable mechanism. The lantern base 365 may include a power source substantially similar to the power source described above for the lantern base 275. It also may include a power button 410 that may be in electrical communication with the power supply within the lantern base 365 such that it can turn on some or all of the panels 280 releasably attached thereto.

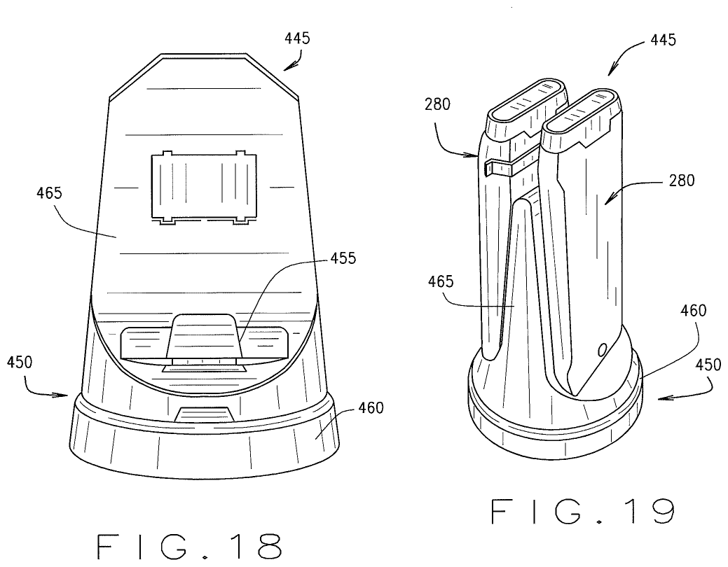

Yet another embodiment of a lantern apparatus 415 is provided in FIG. 17 that includes each of a lantern base 420 and one light panel 280 substantially similar to those described above that is releasably attachable thereto. The lantern base 420 preferably includes at a bottom portion 425 thereof a lip 430 that extends upwardly therefrom. The lip 430 preferably helps to secure the one light panel 280 within the lantern base 420 when it is secured therein. The lantern base 420 also preferably includes a backing 432 located at a rear portion 435 of the lantern base 420 that may also support the light panel 280 when it is releasably secured within the lantern base 420. The backing 432 may also include magnets to attract the magnets 355 on the light panels 280 as described above in other embodiments.

The lantern base 420 also may include a handle 440 extending upwardly therefrom to help a user carry the lantern base 420. The handle 440 may also be in a carabiner-style, as described for the handle 360.

The lantern apparatus 415, like the other embodiments described above, may include a power supply capable of recharging the power supply within the light panel 280, as well as illuminating the light panel 280 when it is cradled in the lantern apparatus 415.

In addition to being charged within a lantern apparatus as described above, the light panels 280 may also be recharged in a rechargeable docking station 445, as shown in FIGS. 18 and 19. A lower portion 450 of the rechargeable docking station 445 preferably includes a cavity 455 with length and width dimensions suitable for receiving a light panel 280 therein. The cavity 455 is thus preferably able to secure a light panel 280 therein when a light panel 280 is being charged. The rechargeable docking station 445 preferably includes a power supply such as a USB or DC power supply or the like that is able to recharge a light panel 280 when docked in the docking station 445. The docking station 445 may recharge light panels 280 via a variety of charging methods including but not limited to wireless charging, USB charging, or micro-USB charging, to name a few.

The docking station 445 shown in FIGS. 18 and 19 includes two opposing cavities 455 on either side of the docking station 445, allowing it to charge two light panels 280 at once, one in each cavity 455. In other embodiments it may include more or fewer cavities to increase its charging capacity. In yet another alternative the docking station may not include a cavity and the light panels 280 may remain in place during charging by their magnets being attracted to one another.

The docking station 445 illustrated includes a circular base portion 460 and a triangular separator 465 that extends upwardly from the base portion 460 to separate the charging light panels 280 from one another. However, in other embodiments, a docking station may take on a number of sizes, shapes, and configurations adequate for securing and charging one or more light panel such as the light panel 280.

As is evident from the foregoing description, certain aspects of the present invention are not limited by the particular details of the examples illustrated herein, and it is therefore contemplated that other modifications and applications, or equivalents thereof, will occur to those skilled in the art. Many changes, modifications, variations and other uses and applications of the present construction will, however, become apparent to those skilled in the art after considering the specification and the accompanying drawings. All such changes, modifications, variations and other uses and applications which do not depart from the spirit and scope of the invention are deemed to be covered by the invention which is limited only by the claims which follow.

What is claimed is:

1. A lantern apparatus, the lantern apparatus comprising:
a lantern base including:
a first power supply;
a first light source connected to the first power supply; and
a basin; and
a plurality of sub-lanterns, each of the plurality of sub-lanterns being removably containable within the basin, and each of the plurality of sub-lanterns including:
a second power supply; and
a second light source connected to the second power supply.

2. The lantern apparatus of claim 1, wherein the lantern includes a base ring attached to a lower portion of the basin.

3. The lantern apparatus of claim 2, wherein the base ring includes the first power supply connected to the first light source.

4. The lantern apparatus of claim 3, wherein the base ring includes a knob for adjusting at least one of a brightness and a color of at least the first light source.

5. The lantern apparatus of claim 1, wherein each of the at least one sub-lanterns has at least one of a micro USB and a USB port for at least one of: charging the second power supply, and supplying power to the second light source.

6. The lantern apparatus of claim 1, wherein each of the at least one sub-lanterns includes two sides illuminable by at least one light source including the second light source.

7. The lantern apparatus of claim 1, wherein each of the at least one sub-lanterns includes a loop at an upper portion of the sub-lantern.

8. The lantern apparatus of claim 1, wherein the lantern apparatus further includes a cover for covering the lantern when not in use.

9. The lantern apparatus of claim 1, wherein the basin is transparent.

10. The lantern apparatus of claim 1, wherein the basin includes a power source for wirelessly providing power to each of the at least one sub-lanterns.

11. A lantern apparatus, the lantern apparatus comprising:
a lantern base including:
a power supply; and
a light source; and
one or more light panels, each of the one or more light panels removably attachable to the lantern base, and each of the one or more light panels having a second power supply.

12. The lantern apparatus of claim 11, wherein each of the one or more light panels include at least one magnet.

13. The lantern apparatus of claim 11, wherein the lantern base includes at least one magnet for releasably engaging an at least one magnet of the one or more light panels.

14. The lantern apparatus of claim 11, wherein the lantern base includes at least two cavities for releasably engaging at least two light panels, respectively.

15. The lantern apparatus of claim 11, wherein each of the one or more light panels has at least one of a micro USB and a USB port for at least one of being charged and providing a charge.

16. The lantern apparatus of claim 11, wherein each of the one or more light panels includes each of an area light and a flashlight.

17. The lantern apparatus of claim 11, wherein each of the one or more light panels includes a hinged handle.

18. The lantern apparatus of claim 11, wherein the lantern base includes a carabiner-style handle.

19. The lantern apparatus of claim 11, wherein each of the one or more light panels includes prong members.

20. The lantern apparatus of claim 19, wherein the lantern base includes electrical contacts that may be selectively engageable with the prong members of the one or more light panels.
